(19) United States
(12) Patent Application Publication
(10) Pub. No.: US 2016/0021360 A1
(43) Pub. Date: Jan. 21, 2016

(54) DISPLAY DEVICE, METHOD OF CONTROLLING DISPLAY DEVICE, AND PROGRAM

(71) Applicant: SEIKO EPSON CORPORATION, Tokyo (JP)

(72) Inventors: Kazuo NISHIZAWA, Matsumoto-shi (JP); Masahide TAKANO, Matsumoto-shi (JP); Yuichi MORI, Minowa-machi (JP)

(21) Appl. No.: 14/748,710

(22) Filed: Jun. 24, 2015

(30) Foreign Application Priority Data
Jul. 16, 2014 (JP) 2014-145670

(51) Int. Cl. H04N 13/04; H04N 13/00; G02B 27/01

(52) U.S. Cl. CPC H04N 13/044; G02B 27/017; H04N 13/0037; H04N 13/0059; H04N 13/0022; H04N 2213/008; G02B 2027/0178; H04N 2013/0077; H04N 2013/0081

(57) ABSTRACT

A head-mount type display device is a transmissive display device adapted to make a user visually recognize an image and transmit an external sight, including an image display section having a left optical image display section adapted to display an image corresponding to a left eye of the user, and a right optical image display section adapted to display an image corresponding to a right eye of the user, an additional information acquisition section adapted to obtain additional information, and a control section adapted to make either of the left optical image display section and the right optical image display section display included in the image display section display the additional information obtained by the additional information acquisition section.

### BACKGROUND

1. Technical Field

The present invention relates to a display device, a method for controlling a display device, and a program.

2. Related Art

In the past, there has been known a display device, which displays a background picture and an object picture other than the background picture in a superimposed manner (see, e.g., JP-A-2011-34086 (Document 1)). Further, there has been known a display device equipped with semi-transmissive displays, which can be mounted in front of the eyes of the user, and displaying information related to an object in the real space viewed by the user so as to be superimposed on the object (see, e.g., JP-A-2013-54661 (Document 2)). The display device of Document 2 is equipped with a camera for taking in the picture of the object viewed in the view field direction of the user. The image of the real space is taken by the camera, and the picture including the object in the real space is obtained. The display device identifies the object out of the picture taken by the camera, then extract additional information of the object thus identified from a storage section, and then displays the additional information so as to be superimposed on the target object in the real space.

In the display device of the related art described above, when the user views the external sight through the transmissive displays, it results that the user views the additional information so as to be superimposed on the object existing in the real space. Therefore, the appearance of the additional information displayed on the transmissive displays and the object in the real space is not kept constant, and in some cases, the additional information cannot clearly be viewed, for example.

### SUMMARY

An advantage of some aspects of the invention is to display information related to a target object or the like which can be viewed as the external sight so as to be viewed with the external sight using a display capable of displaying an image together with the external sight.

A display device according to an aspect of the invention is a transmissive display device adapted to make a user visually recognize an image and transmit an external sight, including an image display section having a first display section adapted to display an image corresponding to a left eye of the user, and a second display section adapted to display an image corresponding to a right eye of the user, an additional information acquisition section adapted to obtain additional information, and a control section adapted to make either one of the first display section and the second display section included in the image display section display the additional information obtained by the additional information acquisition section.

According to this aspect of the invention, since either one of the first display section and the second display section is made to display the additional information, the user can clearly view both of the additional information and the external sight. In other words, it is sufficient for the user to visually recognize the additional information which can be observed with one eye, and it is not required to figure out the additional information which can be observed by the right eye and the additional information which can be observed by the left eye as an image. Therefore, it is possible to resolve an uncomfortable feeling due to the difference between the focal distance the user senses or is aware of in viewing the additional information and the focal distance the user senses or is aware of in viewing the external sight. Thus, the additional information can be displayed with an appropriate method together with the external sight.

The display device may further include an object detection section adapted to detect an object on which the additional information is superimposed out of the external sight visually recognized through the display section, and the control section may make the additional information be displayed so as to be superimposed on the object detected by the object detection section.

According to this aspect of the invention, the additional information can be displayed in an eye-friendly manner so as to be superimposed on the object thus detected.

The display device may further include an imaging section adapted to take an image of the external sight, and the object detection section may detect the object, on which the additional information is superimposed, based on the image taken by the imaging section.

According to this aspect of the invention, since the object on which the additional information is superimposed is detected from the taken image, and then the additional information is displayed, it is possible to detect the object based on the condition of the recognition information set in advance and so on. Thus, in the case in which the display device recognizes the recognition information from the taken image and then operates, an improvement in convenience can be achieved.

The display device may further include a visual line direction detection section adapted to detect a visual line direction of the user, and the control section may determine a display position, at which the additional information is to be displayed, based on the visual line direction detected by the visual line detection section.

According to this aspect of the invention, it is possible to display the additional information of the object located in the visual line direction of the user using an appropriate method together with the external sight to thereby improve the convenience.

The display device may further include a display method selection section adapted to select a display method of the additional information, and the control section may make the additional information be displayed based on the display method selected by the display method selection section.

According to this aspect of the invention, since the display method of the additional information is selected by the display method selection section, the additional information is appropriately displayed together with the external sight, the convenience can be improved.

In the display device, the display method selection section may change the display method of the additional information in accordance with an environment of the external sight.

According to this aspect of the invention, since the display method of the additional information is changed in accordance with the environment of the external sight, it is possible to display the additional information using an appropriate method together with the external sight to thereby improve the convenience.

In the display device, the display method selection section may select a color of the additional information in accordance with a color of the external sight.

According to this aspect of the invention, since the color of the additional information is changed in accordance with the color of the external sight, it is possible to select an eye-friendly color with respect to the external sight, and it is possible to display the additional information using an appropriate method together with the external sight to thereby improve the convenience.

In the display device, the display method selection section may change a transmittance of the additional information in accordance with a brightness of the external sight.

According to this aspect of the invention, since the transmittance of the additional information is changed in accordance with the brightness of the external sight, it is possible to display the additional information using an appropriate method together with the external sight to thereby improve the convenience.

In the display device, the display method selection section may change the display method of the additional information in accordance with importance of the additional information.

According to this aspect of the invention, since the display method of the additional information is changed in accordance with the importance of the additional information, it is possible to display the additional information using an appropriate method together with the external sight to thereby improve the convenience.

n the display device, the display method selection section may switch whether either one of the first display section and the second display section is made to display the additional information or both of the first display section and the second display section are made to display the additional information in accordance with a type of the additional information.

According to this aspect of the invention, whether the display of the additional information is performed on one of the display sections or performed on both of the display sections is switched in accordance with the type of the additional information. Thus, it is possible to display the additional information with an appropriate method together with the external sight to thereby improve the convenience.

Another aspect of the invention is directed to a method of controlling a transmissive display device adapted to make a user visually recognize an image and transmit an external sight, including providing an image display section having a first display section adapted to display an image corresponding to a left eye of the user, and a second display section adapted to display an image corresponding to a right eye of the user, obtaining additional information, and making either one of the first display section and the second display section display the additional information.

According to this aspect of the invention, since either one of the first display section and the second display section is made to display the additional information, the user can clearly view both of the additional information and the external sight, and thus, the additional information can be displayed with an appropriate method together with the external sight.

Still another aspect of the invention is directed to a computer executable program adapted to control a transmissive display device adapted to make a user visually recognize an image and transmit an external sight, including an image display section having a first display section adapted to display an image corresponding to a left eye of the user, and a second display section adapted to display an image corresponding to a right eye of the user, the program making a computer function as a device including an additional information acquisition section adapted to obtain additional information, and a control section adapted to make either one of the first display section and the second display section display the additional information obtained by the additional information acquisition section.

According to this aspect of the invention, since either one of the first display section and the second display section is made to display the additional information, the user can clearly view both of the additional information and the external sight, and thus, the additional information can be displayed with an appropriate method together with the external sight.

### BRIEF DESCRIPTION OF THE DRAWINGS

The invention will be described with reference to the accompanying drawings, wherein like numbers reference like elements.

FIG. 1 is an explanatory diagram showing an exterior configuration of a head-mount type display device.

FIG. 2 is a block diagram showing a functional configuration of the head-mount type display device.

FIG. 3 is a flowchart showing an operation of the head-mount type display device.

FIGS. 4A through 4C are explanatory diagrams each showing an example of display of the head-mount type display device.

FIGS. 5A and 5B are explanatory diagrams each showing another example of the display of the head-mount type display device.

### DESCRIPTION OF AN EXEMPLARY EMBODIMENT

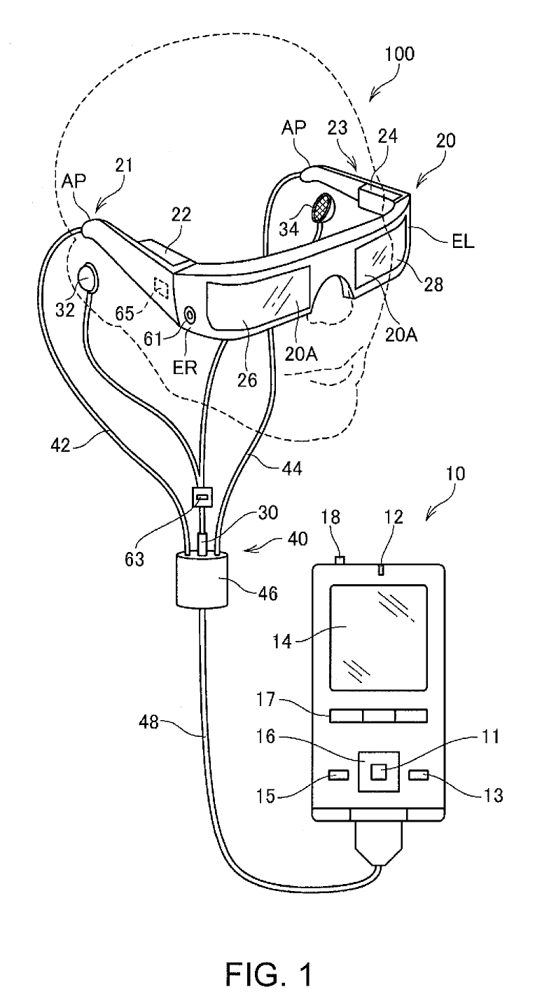

An embodiment of the invention will hereinafter be explained with reference to the accompanying drawings. FIG. 1 is an explanatory diagram showing an exterior configuration of a head-mount type display device 100. The head-mount type display device 100 is a display device to be mounted on the head, and is also called a head-mounted display (HMD). The head-mount type display device 100 according to the present embodiment is an optical transmissive head-mount type display device allowing the user to visually recognize a virtual image and at the same time visually recognize an external sight directly. It should be noted that in the present specification, the virtual image to be visually recognized by the user using the head-mount type display device 100 is also referred to as a “display image” for the sake of convenience. Further, emission of the image light generated based on the image data is also referred to as “display of the image.”

The head-mount type display device 100 is provided with an image display section 20 (a display section) for making the user visually recognize the virtual image in the state of being mounted on the head of the user, and a control section 10 (a controller) for controlling the image display section 20.

The image display section 20 is a mounting body to be mounted on the head of the user, and has a shape of a pair of glasses in the present embodiment. The image display section 20 is provided with a right holding section 21, a right display drive section 22, a left holding section 23, a left display drive section 24, a right optical image display section 26, a left optical image display section 28, a camera 61, and a microphone 63. The right optical image display section 26 and the left optical image display section 28 are disposed so as to be located in front of the right and left eyes of the user, respectively, when the user wears the image display section 20. One end of the right optical image display section 26 and one end of the left optical image display section 28 are connected to each other at a position corresponding to the glabella of the user when the user wears the image display section 20.

The right holding section 21 is a member disposed so as to extend from an end portion ER, which is the other end of the right optical image display section 26, to a temporal region of the head of the user when the user wears the image display section 20. Similarly, the left holding section 23 is a member disposed so as to extend from an end portion EL, which is the other end of the left optical image display section 28, to a temporal region of the head of the user when the user wears the image display section 20. The right holding section 21 and the left holding section 23 hold the image display section 20 in the head of the user in such a manner as the temples of the pair of glasses.

The right display drive section 22 and the left display drive section 24 are disposed on the sides to be opposed to the head of the user when the user wears the image display section 20. It should be noted that hereinafter the right holding section 21 and the left holding section 23 are also collectively referred to simply as “holding sections,” the right display drive section 22 and the left display drive section 24 are collectively referred to simply as “display drive sections,” and the right optical image display section 26 and the left optical image display section 28 are also collectively referred to simply as “optical image display sections.”

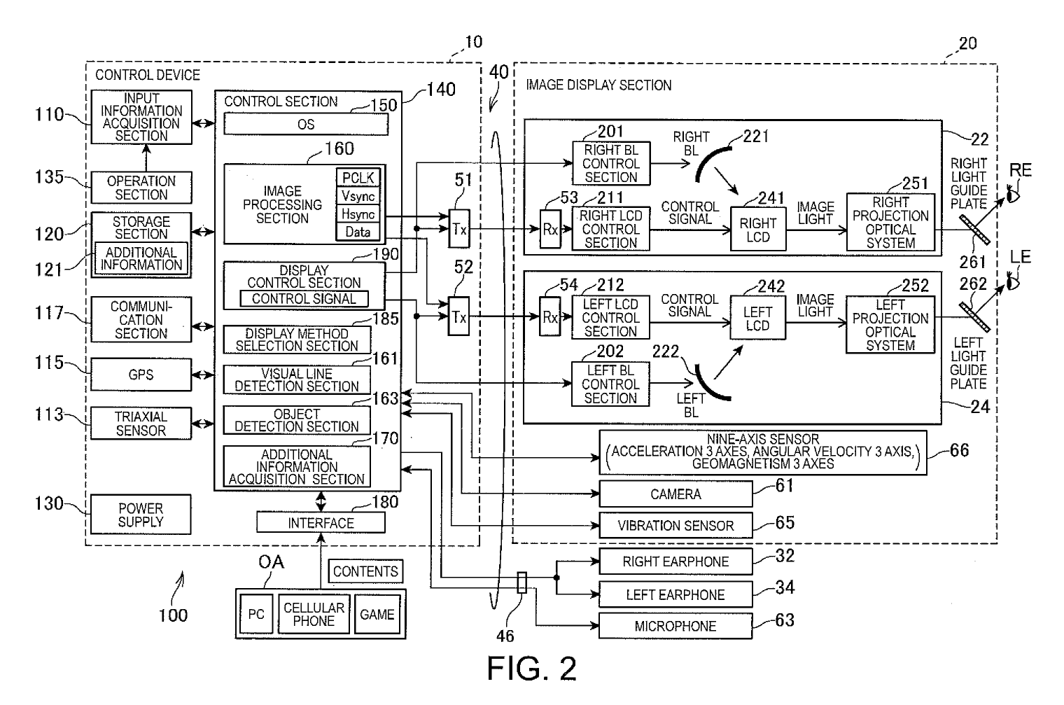

The display drive sections 22, 24 include liquid crystal displays 241, 242 (hereinafter also referred to as “LCDs 241, 242”), projection optical systems 251, 252, and so on (see FIG. 2). The details of the configuration of the display drive sections 22, 24 will be described later. The optical image display sections 26, 28 as optical members include light guide plates 261, 262 (see FIG. 2), respectively. Further, it is also possible to dispose a dimming plate (not shown) on the front side of each of the optical image display sections 26, 28. The light guide plates 261, 262 are each formed of light transmissive resin or the like, and guide the image light output from the display drive sections 22, 24 to the eyes of the user, respectively. The dimming is a thin-plate like optical element, and it is sufficient for the dimming plate to be disposed so as to cover the obverse side of the image display section 20, which is the side opposite to the side of the eyes of the user. As the dimming plate, there are used a variety of members such as a member with nearly zero light permeability, a nearly transparent member, a member for transmitting light while reducing the light intensity, or a member for attenuating or reflecting the light with a specific wavelength. By appropriately selecting the optical characteristics (e.g., the light transmittance) of the dimming plate, it is possible to control the intensity of the outside light externally entering the right optical image display section 26 and the left optical image display section 28 to thereby control easiness of the visual recognition of the virtual image. In the description of the present embodiment, there is explained at least the case of using the dimming plate having such light transmittance that the user wearing the head-mount type display device 100 can visually recognize the outside scenery. The dimming plates serve to protect the right light guide plate 261 and the left light guide plate 262 to suppress damages, adhesion of dirt, and so on to the right light guide plate 261 and the left light guide plate 262.

The dimming plates can be arranged to be detachably attached to the right optical image display section 26 and the left optical image display section 28, or can be arranged so that a plurality of types of dimming plates can be attached while being replaced with each other.

The camera 61 is disposed in the end portion ER, which is the other end of the right optical image display section 26. The camera 61 takes the image of the external sight, which is the outside scenery in an opposite side direction to the side of the eyes of the user, to thereby obtain the external sight image. The camera 61 in the present embodiment shown in FIG. 1 is a monocular camera, but can also be a stereo camera.

The camera 61 takes the image in the obverse side direction of the head-mount type display device 100. The field angle of the camera 61 is in the direction for taking an image of at least a part of the external sight in the direction of the field of view of the user in the state of wearing the head-mount type display device 100. Further, although the size of the field angle of the camera 61 can arbitrarily be set, it is preferable that the imaging range of the camera 61 corresponds to the range including the external sight visually recognized by the user through the right optical image display section 26 and the left optical image display section 28. Further, it is more preferable that the imaging range of the camera 61 is set so that the image of the entire field of view of the user through the dimming plate can be taken.

The image display section 20 further includes a connection section 40 for connecting the image display section 20 to the control device 10. The connection section 40 includes a main body cord 48 to be connected to the control device 10, a right cord 42, a left cord 44, and a coupling member 46. The main body cord 48 is branched into two cords to form the right cord 42 and the left cord 44. The right cord 42 is inserted into the housing of the right holding section 21 from a tip portion AP in the extending direction of the right holding section 21, and is connected to the right display drive section 22. Similarly, the left cord 44 is inserted into the housing of the left holding section 23 from a tip portion AP in the extending direction of the left holding section 23, and is connected to the left display drive section 24.

The coupling member 46 is disposed at a branch point of the main body cord 48, and the right cord 42 and the left cord 44, and has a jack to which an earphone plug 30 is connected. A right earphone 32 and a left earphone 34 extend from the earphone plug 30. A microphone 63 is disposed in the vicinity of the earphone plug 30. The wiring from the earphone plug 30 to the microphone 63 is bundled as a single cord, then the cord is branched at the microphone 63 to be connected respectively to the right earphone 32 and the left earphone 34.

It is also possible to bundle the right cord 42 and the left cord 44 into a single cord. Specifically, it is also possible to lead in the conductor wires inside the right cord 42 on the left holding section 23 side through the inside of the main body of the image display section 20, and then cover the conductor wires with resin together with the conductor wires located inside the left cord 44 to thereby bundle the conductor wires into a single cord.

The image display section 20 and the control device 10 perform transmission of various signals via the connection section 40. There are provided connecters (not shown) to be fitted with each other respectively to an end portion of the main body cord 48 on the opposite side to the coupling member 46 and the control device 10. The control device 10 and the image display section 20 are connected to each other or separated from each other in accordance with fitting/releasing of the connector of the main body cord 48 and the connector of the control device 10. As the right cord 42, the left cord 44, and the main body cord 48, there can be adopted, for example, metal cables or optical fibers.

The control device 10 is a device for controlling the head-mount type display device 100. The control device 10 is provided with switches including a determination key 11, a lighting section 12, a display switching key 13, a luminance switching key 15, arrow keys 16, a menu key 17, and a power switch 18. Further, the control device 10 is provided with a track pad 14 on which the user performs a touch operation.

The determination key 11 detects a holding-down operation, and then outputs a signal for determining the content of the operation in the control device 10. The lighting section 12 gives notice of the operating state of the head-mount type display device 100 with the lighting state of the lighting section 12. As the operating state of the head-mount type display device 100, there can be cited, for example, an ON/OFF state of the power. As the lighting section 12, there is used, for example, a light emitting diode (LED). The display switching key 13 detects a holding-down operation, and then outputs, for example, a signal for switching the display mode of the content moving image between a 3D mode and a 2D mode.

The track pad 14 detects the finger operation of the user on the operation surface of the track pad 14, and then outputs a signal corresponding to the detection content. As the track pad 14, there can be adopted a variety of types of track pad such as an electrostatic track pad, a pressure-detection track pad, or an optical track pad. The luminance switching key 15 detects a holding-down operation, and then outputs a signal for increasing or decreasing the luminance of the image display section 20. The arrow keys 16 detect a holding-down operation to the keys corresponding to up, down, right, and left directions, and then output a signal corresponding to the detection content. The power switch 18 detects a sliding operation of the switch to thereby switch the powering state of the head-mount type display device 100.

FIG. 2 is a functional block diagram of the head-mount type display device 100. As shown in FIG. 2, the control device 10 includes a control section 140, an operation section 135, an input information acquisition section 110, a storage section 120, a power supply 130, an interface 180, a transmission section (Tx) 51, and a transmission section (Tx) 52.

The operation section 135 detects the operation performed by the user. The operation section 135 is provided with the sections of the determination key 11, the display switching key 13, the track pad 14, the luminance switching key 15, the arrow keys 16, the menu key 17, and the power switch 18 shown in FIG. 1.

The input information acquisition section 110 obtains the signal corresponding to the operation input made by the user. As the signals corresponding to the operation inputs, there can be cited the signals corresponding to the operation inputs with respect to, for example, the track pad 14, the arrow keys 16, and the power switch 18.

The power supply 130 supplies each of the sections of the head-mount type display device 100 with the electrical power. As the power supply 130, a secondary cell, for example, can be used.

The storage section 120 stores a variety of computer programs. The storage section 120 includes a ROM, a RAM, and so on.

The control section 140 is provided with a CPU, a ROM, a RAM, and so on, and executes the program stored in the ROM or the storage section 12 to thereby control each of the sections of the head-mount type display device 100. The control section 140 executes the program described above to thereby function as an operating system (OS) 150 as a basic control system of the head-mount type display device 100. Further, the control section 140 executes the program described above to thereby function as an image processing section 160, a visual line detection section 161, an object detection section 163, a display method selection section 185, an additional information acquisition section 170, and a display control section 190. These functions can be a part of the operating system 150, or can also be the functions of the application programs operating on the operating system 150.

The image processing section 160 obtains the image signal included in the content. The image processing section 160 separates sync signals such as a vertical sync signal VSync and a horizontal sync signal HSync from the image signal thus obtained. Further, the image processing section 160 generates a clock signal PCLK using a phase locked loop (PLL) circuit or the like (not shown) in accordance with the periods of the vertical sync signal. VSync and the horizontal sync signal HSync thus separated. The image processing section 160 converts the analog image signal, from which the sync signals are separated, into a digital image signal using an A/D conversion circuit or the like (not shown). Subsequently, the image processing section 160 stores the digital image signal obtained by the conversion into a DRAM in the storage section 120 frame by frame as the image data (Data in the drawing) of the object image. The image data is, for example, RGB data.

It should be noted that it is also possible for the image processing section 160 to perform image processing such as a resolution conversion process, various color correction processes of, for example, adjustment of luminance and chromaticness, or a keystone distortion correction process on the image data if necessary.

The image processing section 160 transmits each of the clock signal PCLK, the vertical sync signal VSync, the horizontal sync signal HSync thus generated, and the image data Data stored in the DRAM in the storage section 120 via each of the transmission sections 51, 52. It should be noted that the image data Data transmitted via the transmission section 51 is also referred to as “right eye image data, ” and the image data Data transmitted via the transmission section 52 is also referred to as “left eye image data.” The transmission sections 51, 52 function as transmitters for serial transmission between the control device 10 and the image display section 20.

The display control section 190 generates control signals for controlling the right display drive section 22 and the left display drive section 24. Specifically, the display control section 190 controls to switch ON/OFF the drive of a right LCD 241 by a right LCD control section 211, to switch ON/OFF the drive of a right backlight 221 by a right backlight control section 201, to switch ON/OFF the drive of a left LCD 242 by a left LCD control section 212, to switch ON/OFF the drive of a left backlight 222 by a left backlight control section 202, and so on individually using the control signals. Thus, the display control section 190 controls generation and emission of the image light by each of the right display drive section 22 and the left display drive section 24. For example, the display control section 190 makes both of the right display drive section 22 and the left display drive section 24 generate image light, makes either of them generate the image light, or inhibits the both from generating the image light.

The display control section 190 transmits the control signals to the right LCD control section 211 and the left LCD control section 212 via the transmitting sections 51, 52, respectively. Further, the display control section 190 transmits the control signals to the right backlight control section 201 and the left backlight control section 202, respectively.

The visual line detection section 161 detects the visual line direction of the user from the direction of the image display section 20 detected by a nine-axis sensor 66 described later. It should be noted that the visual line detection section 161 can also have a configuration capable of obtaining the eye image of the user to accurately detect the gaze position of the user.

The object detection section 163 controls the camera 61 to perform imaging (shooting) to thereby obtain the image data of the taken image. The head-mount type display device 100 is capable of performing a plurality of operation modes including at least an information display mode for displaying additional information related to the object existing in the real space on the image display section 20, and a normal operation mode in which the additional information related to the object existing in the real space is not displayed. The head-mount type display device 100 can switch to execute the normal mode and the information display mode. In the information display mode, the object detection section 163 makes the camera 61 operate to perform imaging to obtain the taken image data. In the information display mode, the camera 61 continuously performs imaging with a period set in advance due to the control of the object detection section 163, and the object detection section 163 obtains the taken image data every time one frame is imaged. The operation of the object detection section 163 making the camera 61 perform imaging can also be the same as the operation in the case of taking a moving image with the camera 61. Further, in the information display mode, the imaging range of the camera 61 can automatically be set so that the entire view field of the user can be imaged. It should be noted that although in the present embodiment there is adopted the configuration in which the object detection section 163 controls the camera 61 to perform imaging, the invention is not limited to this configuration, but the camera 61 can be controlled to perform imaging by another function of the control section 140. For example, it is also possible that imaging is performed in response to the operation of the operation section 135 by the user, and the image taken by the camera 61 is input to the object detection section 163. Further, it is also possible that the visual line detection section 161 detects the fact that the visual line of the user is fixed to a point, and the visual line detection section 161 controls the camera 61 to perform imaging.

Further, the object detection section 163 obtains the present position of the control device 10 obtained by the GPS 115 described later. Further, the object detection section 163 obtains the visual line direction of the user detected by the visual line detection section 161.

The object detection section 163 has a function of detecting the image corresponding to recognition information set in advance from the taken image taken by the camera 61. The recognition information set in advance corresponds to, for example, an image of the object to be detected, a pattern of the pixels values of a plurality of pixels, and so on. Such recognition information is stored in the storage section 120 in advance. The object detection section 163 detects the object in the shot image using image recognition based on the taken image taken by the camera 61 and the image of the object stored in advance in the storage section 120. Further, the pattern of the pixel values of the plurality of pixels is a so-called marker such as a two-dimensional code such as a QR code (registered trademark), or a one-dimensional code, and can optically be read and recognized by a computer, and is an image from which the computer can obtain information. The object detection section 163 detects the marker described above from the taken image taken by the camera 61. It should be noted that although in the present embodiment there is adopted the configuration in which the object detection section 163 detects the recognition information from the taken image taken by the camera 61, the invention is not limited to this configuration, but the recognition information can be detected from the taken image taken by the camera 61 by another function of the control section 140. Further, it is also possible to adopt a configuration in which the recognition information is identified using an operation of the user on the operation section 135, and the object detection section 163 can detect the object based on the recognition information thus identified.

In the storage section 120, the recognition information, the positional information, and the additional information of the object to be detected are stored with strings attached. In some cases, the taken image taken by the camera 61 includes a plurality of objects. The object detection section 163 identifies the object to be detected based on the present position of the control device 10 obtained by the GPS 115, the visual line direction of the user detected by the visual line detection section 161, the recognition information detected in the taken image taken by the camera 61, and the positional information with strings attached to the respective recognition information. Further, the object detection section 163 obtains the pixel coordinates of the object thus detected in the LCD 241 and the LCD 242, respectively. The coordinate in the taken image taken by the camera 61, the positions where the images (virtual images) of the light guide plate 261 and the light guide plate 262 are viewed by the user, respectively, and the pixel coordinates in the LCD 241 and the LCD 242 are made to correspond to each other in advance. The object detection section 163 detects the object from the taken image to obtain the coordinate of the object in the taken image. The object detection section 163 obtains the pixel coordinates of the object in the LCD 241 and the LCD 242, respectively, based on the coordinate of the object in the taken image.

It should be noted that the object detection section 163 is realized as a function of the control section 140, and the action described above and performed by the object detection section 163 can also be realized by another function of the control section 140.

The additional information acquisition section 170 obtains the additional information related to the object detected by the object detection section 163. The additional information acquisition section 170 checks the object detected by the object detection section 163 in the information stored in an additional information database 121 to obtain the additional information of the object stored with a string attached to the object.

The display method selection section 185 obtains the image data of the taken image taken by the camera 61. Further, the display method selection section 185 obtains the additional information from the additional information acquisition section 170. The display method selection section 185 selects the display method based on the taken image taken by the camera 61 and the additional information related to the object.

To the control section 140, there are connected a triaxial sensor 113, the GPS 115, and a communication section 117. The triaxial sensor 113 is a triaxial acceleration sensor, and it is possible for the control section 140 to obtain the detection value of the triaxial sensor 113 to detect the motion and the direction of the motion of the control device 10.

The GPS 115 is provided with an antenna, and receives a GPS (Global Positioning System) signal to obtain the present position of the control device 10. The GPS 115 outputs the present position and the current time, which have been obtained based on the GPS signal, to the control section 140. Further, it is also possible for the GPS 115 to be provided with a function of obtaining the current time based on the information included in the GPS signal to correct the time kept by the control section 140 of the control device 10. Further, it is also possible for the GPS 115 to be provided with a function of identifying the facility corresponding to the present position from the latitude and the longitude of the present position obtained based on the GPS signal.

The communication section 117 performs wireless data communication compliant with the wireless LAN (WiFi (registered trademark)), Miracast (registered trademark), or Bluetooth (registered trademark) standard.

The interface 180 is an interface for connecting a variety of types of image supply devices OA to be a supply source of contents to the control device 10. The contents supplied by the image supply devices OA include a still image or a moving image, and can also include a sound. As the image supply devices OA, there can be cited, for example, a personal computer (PC), a cellular phone terminal, and a game terminal. As the interface 180, there can be used, for example, a USB interface, a micro USB interface, and an interface for a memory card.

Here, it is also possible to connect the image supply device OA to the control device 10 with a wireless communication line. In this case, the image supply device OA performs the wireless communication together with the communication section 117 to transmit the data of the contents using the wireless communication technology such as Miracast (registered trademark).

The storage section 120 is provided with the additional information database 121 for storing the additional information of the detection object with strings attached to the recognition information for recognizing the detection object and the positional information of the detection object. The additional information database 121 stores the information related to the object so as to be layered based on the positional information (e.g., the information such as the name of the facility) of the object. Further, it is also possible for the control device 10 to make the communication section 117 or the interface 180 obtain the information related to the object related to the present position from the image supply device OA based on the own positional information (e.g., the information of the facility or the like corresponding to the present position). It should be noted that the additional information database 121 is not limited to the configuration of being provided to the storage section 120, but it is also possible for the image supply device OA to be provided with the additional information database. In this case, it is also possible for the control device 10 to perform wireless communication with the image supply device OA using the communication section 117 to thereby obtain the information, which is stored in the additional information database, on an as needed basis.

The image display section 20 is provided with the right display drive section 22, the left display drive section 24, the right light guide plate 261 as the right optical image display section 26, the left light guide plate 262 as the left optical image display section 28, the camera 61, a vibration sensor 65, and the nine-axis sensor 66.

The vibration sensor 65 is configured using an acceleration sensor, and is disposed inside the image display section 20 as shown in FIG. 1. In the example shown in FIG. 1, the vibration sensor 65 is incorporated in the right holding section 21 in the vicinity of the end portion ER of the right optical image display section 26. In the case in which the user performs an operation (a knock operation) of knocking the end portion ER, the vibration sensor 65 detects the vibration due to this operation, and then outputs the detection result to the control section 140. Due to the detection result of the vibration sensor 65, the control section 140 detects the knock operation by the user.

The nine-axis sensor 66 is a motion sensor for detecting accelerations (three axes), angular velocities (3 axes), and geomagnetisms (3 axes). The nine-axis sensor 66 is provided to the image display section 20, and therefore detects a movement of the head of the user when the image display section 20 is mounted on the head of the user. For example, it is possible for the control section 140 to determine the direction of the image display section 20 from the movement of the head of the user detected by the nine-axis sensor 66 to thereby estimate the visual line direction of the user.

The right display drive section 22 is provided with a receiving section (Rx) 53, the right backlight (BL) control section 201 and the right backlight (BL) 221 functioning as a light source, the right LCD control section 211 and the right LCD 241 functioning as a display element, and a right projection optical system 251. The right backlight control section 201 and the right backlight 221 function as the light source. The right LCD control section 211 and the right LCD 241 function as the display element. It should be noted that the right backlight control section 201, the right LCD control section 211, the right backlight 221, and the right LCD 241 are also collectively referred to as an “image light generation section.”

The receiving section 53 functions as a receiver for serial transmission between the control device 10 and the image display section 20. The right backlight control section 201 drives the right backlight 221 based on the control signal input to the right backlight control section 201. The right backlight 221 is a light emitter such as an LED or electroluminescence (EL). The right LCD control section 211 drives the right LCD 241 based on the clock signal PCLK input via the receiving section 53, the vertical sync signal VSync, the horizontal sync signal HSync, and right-eye image data Data1. The right LCD 241 is a transmissive liquid crystal panel having a plurality of pixels arranged in a matrix.

The right projection optical system 251 is formed of a collimating lens for converting the image light emitted from the right LCD 241 into a light beam in a parallel state. The right light guide plate 261 as the right optical image display section 26 guides the image light, which is output from the right projection optical system 251, to the right eye RE of the user while reflecting the image light along a predetermined light path. It should be noted that the right projection optical system 251 and the right light guide plate 261 are also collectively referred to as a “light guide section.”

The left display drive section 24 has substantially the same configuration as that of the right display drive section 22. The left display drive section 24 is provided with a receiving section (Rx) 54, the left backlight (BL) control section 202 and the left backlight (BL) 222 functioning as the light source, the left LCD control section 212 and the left LCD 242 functioning as the display element, and a left projection optical system 252. The left backlight control section 202 and the left backlight 222 function as the light source. The left LCD control section 212 and the left LCD 242 function as the display element. It should be noted that the left backlight control section 202, the left LCD control section 212, the left backlight 222, and the left LCD 242 are also collectively referred to as an “image light generation section.” Further, the left projection optical system 252 is formed of a collimating lens for converting the image light emitted from the left LCD 242 into a light beam in a parallel state. The left light guide plate 262 as the left optical image display section 28 guides the image light, which is output from the left projection optical system 252, to the left eye LE of the user while reflecting the image light along a predetermined light path. It should be noted that the left projection optical system 252 and the left light guide plate 262 are also collectively referred to as a “light guide section.”

Further, the left display drive section 24 and the left light guide plate 262 constitute a first display section for displaying an image corresponding to the left eye of the user. Further, the right display drive section 22 and the right light guide plate 261 constitute a second display section for displaying an image corresponding to the right eye of the user.

The head-mount type display device 100 performs imaging with the camera 61, and operates using the taken image data taken by the camera 61 in the information display mode. As shown in FIG. 1, the camera 61 is provided to the image display section 20 to be mounted on the head of the user. Therefore, the imaging direction of the camera 61 is the same as the visual line direction of the user, and thus the things located in the viewing direction of the user are conveniently imaged. The operation of the head-mount type display device 100 in the information display mode will hereinafter be explained in detail. In the following explanation, as an embodiment of the information display mode, there is used an example of displaying the information such as where a target book area is located in a library, or what kind of book the book looked by the user is.

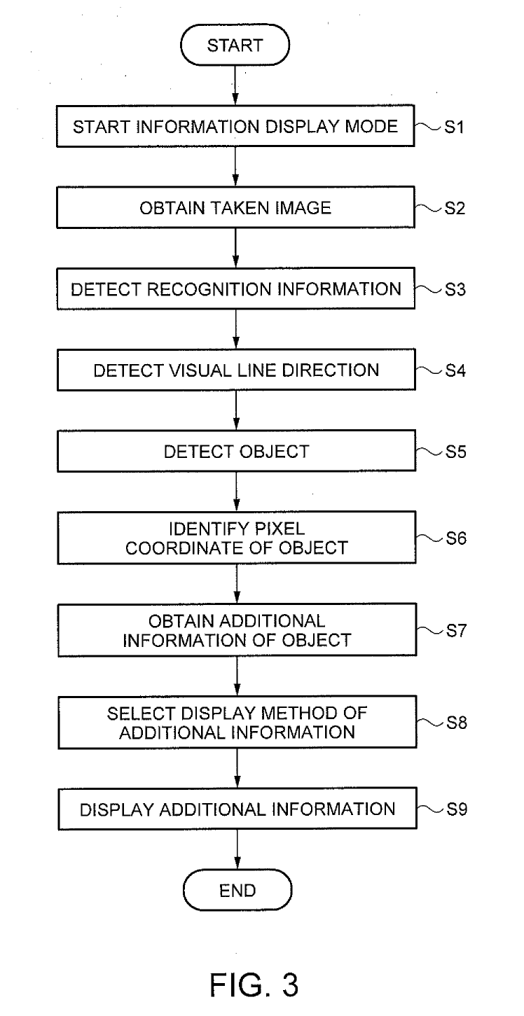

FIG. 3 is a flowchart showing the operation of the head-mount type display device 100, and in particular showing the operation related to the execution of the information display mode.

The information display mode is started by the control section 140 based on the operation by the user on the operation section 135. When the control section 140 starts (step S1) the information display mode, the object detection section 163 makes the camera 61 start imaging to obtain (step S2) the taken image data. Then, the object detection section 163 detects (step S3) the recognition information showing up in the taken image taken by the camera 61. The object detection section 163 obtains the present position information from the GPS 115, and then detects the recognition information, which matches the recognition information such as a marker or an image of the object stored in the additional information database 121 with strings attached to the present position information, from the taken image. In the example of the library, the image of the object corresponds to the image of the cover of a book or a magazine, the image of a guidance sign displayed in the library, and so on. The object detection section 163 detects the marker identical to a marker, which is stored in the additional information database 121, in the taken image taken by the camera 61. Further, the object detection section 163 checks whether or not the object matching the image, which is stored in the additional information database 121, exists in the taken image taken by the camera 61. The object detection section 163 performs object recognition by searching the additional information database 121 for the image having a local pattern roughly coinciding with the local pattern in the taken image taken by the camera 61.

Subsequently, the visual line detection section 161 detects (step S4) the visual line direction and/or the gaze position of the user. The object detection section 163 obtains the visual line direction and/or the gaze position of the user detected by the visual line detection section 161. The object detection section 163 identifies the recognition information located in the visual line direction and/or at the gaze position of the user out of the recognition information detected from the taken image. The object detection section 163 detects (step S5) the object with a string attached to the recognition information thus identified with reference to the additional information database 121. Further, the object detection section 163 identifies (step S6) the pixel coordinates of the object thus detected in the LCD 241 and the LCD 242, respectively.

Subsequently, the additional information acquisition section 170 checks the object detected by the object detection section 163 in the information stored in the additional information database 121 to obtain (step S7) the additional information stored with a string attached to the object. In the case in which the object is a book, the additional information corresponds to the information such as an introduction of the book or whether or not the book is the latest publication.

The display method selection section 185 selects (step S8) the display method for displaying the additional information of the object detected by the object detection section 163. The display method selection section 185 obtains the additional information of the object obtained by the additional information acquisition section 170. Further, the display method selection section 185 obtains the taken image data taken by the camera 61. The display method selection section 185 selects the display method of the additional information based on the additional information of the object thus obtained and the taken image taken by the camera 61.

The display method selection section 185 analyzes the taken image taken by the camera 61 to obtain the hue and the luminosity of the external sight. Further, the display method selection section 185 detects a risk factor in the external sight based on the taken image taken by the camera 61. For example, the display method selection section 185 detects such a risk factor that a lot of moving objects are included in the external sight based on the plurality of taken images continuously taken by the camera 61.

The display method selection section 185 selects the display color for displaying the additional information in accordance with the hue of the external sight. The display method selection section 185 analyzes the hue of the taken image taken by the camera 61 to select the color, which rarely appears in the external sight, as the display color of the additional information.

Further, the display method selection section 185 selects whether either one of the right optical image display section 26 and the left optical image display section 28 is made to display the additional information, or both of the right optical image display section 26 and the left optical image display section 28 are made to display the additional information in accordance with the type of the additional information.

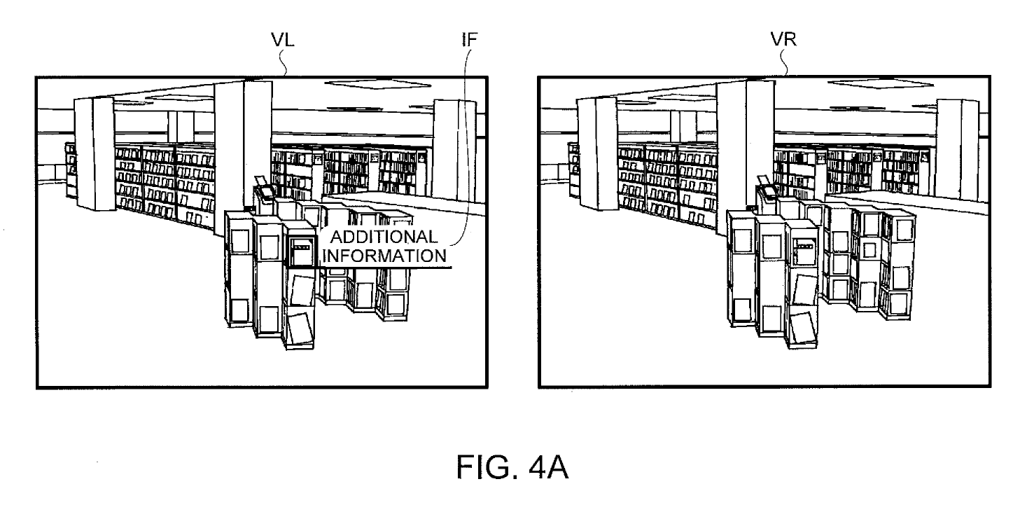

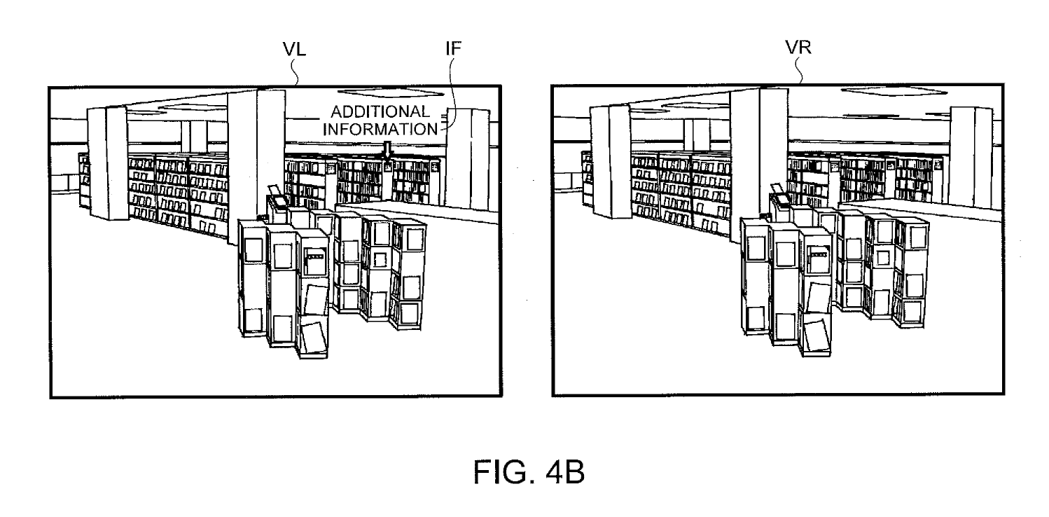

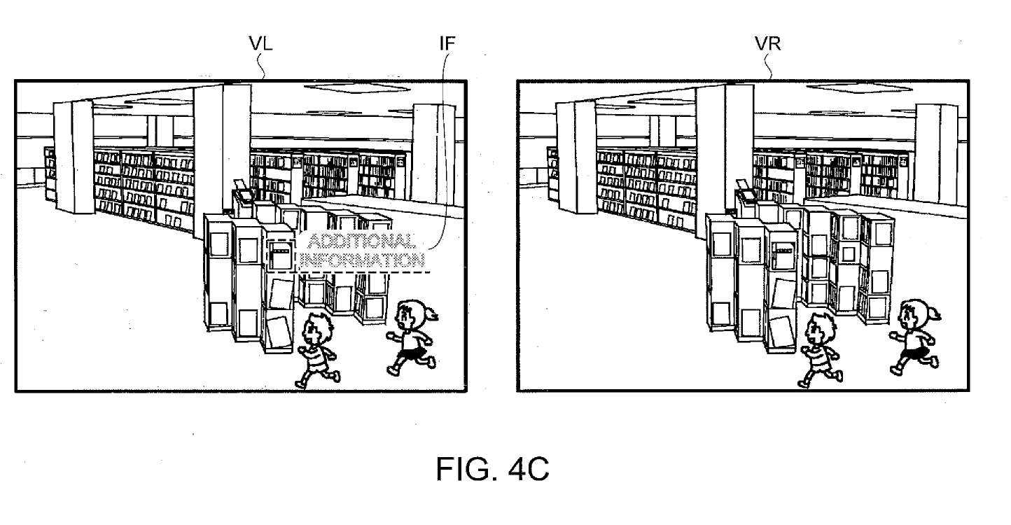

FIGS. 4A, 4B, and 4C are explanatory diagrams each showing a display example of the head-mount type display device 100.

In the case in which the additional information is the information easy to visually recognize together with the external sight such as characters or symbols, the display method selection section 185 selects the display method for displaying the additional information in either one of the right optical image display section 26 and the left optical image display section 28 as shown in FIG. 4A. In FIG. 4A, the additional information IF related to the book as the object is displayed in the left display image VL displayed on the left optical image display section 28. In other words, the additional information IF of the object is displayed so as to be visible only to the left eye of the user. Thus, it is possible for the user to visually recognize clearly the external sight and the additional information displayed so as to be superimposed on the external sight without adjusting the focal distance. It should be noted that it is also possible to adopt the configuration in which the user can set which one of the right optical display section 26 and the left optical image display section 28 is made to display the additional information using the operation to the operation section 135 in the case in which there is selected the display method of making either one of the display sections display the additional information.

Further, the display method selection section 185 obtains the present position of the control device 10 and the positional information of the object detected by the object detection section 163 to select the display size of the additional information based on the positional relationship with the object. As shown in FIG. 4A, the display method selection section 185 selects the display method of displaying the additional information large in size in the case in which the distance from the object is short. Further, as shown in FIG. 4B, the display method selection section 185 selects the display method of displaying the additional information small in size in the case in which the distance from the object is long. FIG. 4B shows an example of the display image of the case in which a bookshelf located at a position distant from the user is detected as the object. As shown in FIG. 4B, the additional information IF (e.g., a classification of the books set out in the bookshelf) related to the bookshelf detected as the object is displayed on the left optical image display section 28 as the left display image VL together with an arrow pointing to the bookshelf. As described above, since the display method selection section 185 changes the display size of the additional information in accordance with the distance between the user and the object, the user can sensuously figure out the distance to the object.

Further, it is also possible for the display method selection section 185 to select the display method of the additional information in accordance with the object. As shown in FIG. 4A, in the case in which, for example, the object is a single body, the display method selection section 185 selects the display method of displaying the additional information using a line words balloon surrounding the object with a frame. Further, as shown in FIG. 4B, in the case in which, for example, the object spreads throughout a specific range, the display method selection section 185 selects the display method of displaying the additional information together with an arrow pointing to the range of the object.

Further, it is also possible for the display method selection section 185 to decrease the transmittance in displaying the additional information when the external sight is bright, or to increase the transmittance in displaying the additional information when the external sight is dark. Further, it is also possible for the display method selection section 185 to decrease the transmittance in displaying the additional information IF to give priority to eye-friendliness of the external sight as shown in FIG. 4C in the case in which the risk factor such as an moving object is detected in the external sight. FIG. 4C shows an example of the display image in the case in which moving children are detected in the external sight. As shown in FIG. 4C, in the case in which the moving object is detected in the external sight, the display method selection section 185 selects the display method of displaying the additional information IF of the left display image VL displayed on the left optical image display section 28 at a high transmittance. Thus, the user can visually recognize the moving children in the external sight together with the additional information. As described above, the display method selection section 185 selects the display method of the additional information in accordance with the environment of the external sight such as the case in which a number of things are included in the external sight or the case in which the external sight is too bright. The display method selection section 185 can arbitrarily select the color and the transmittance for displaying the additional information in accordance with the environment of the external sight. Further, it is also possible for the display method selection section 185 to determine whether or not the additional information is displayed in accordance with the environment of the external sight. It is also possible for the display method selection section 185 to select the display method of, for example, showing the detected object so as to be surrounded by a frame.

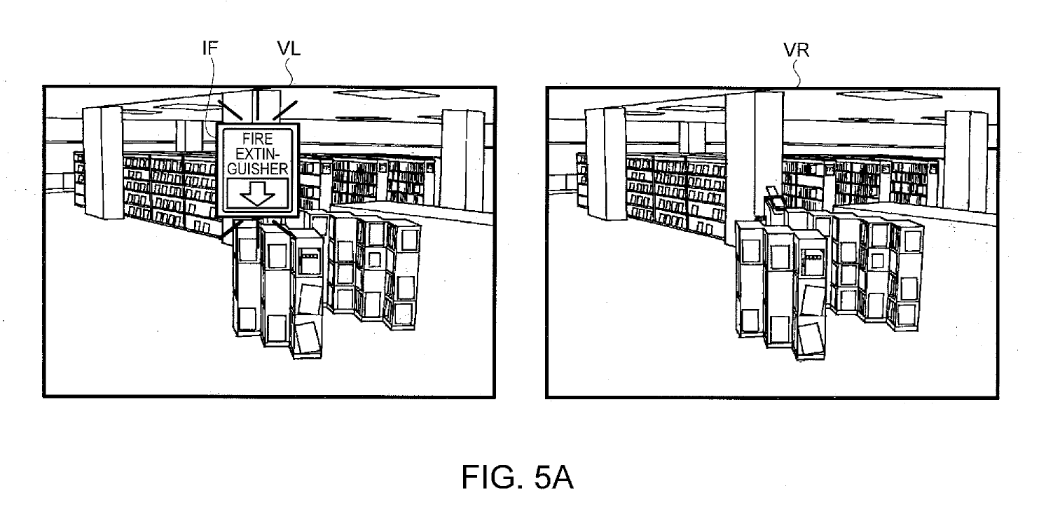

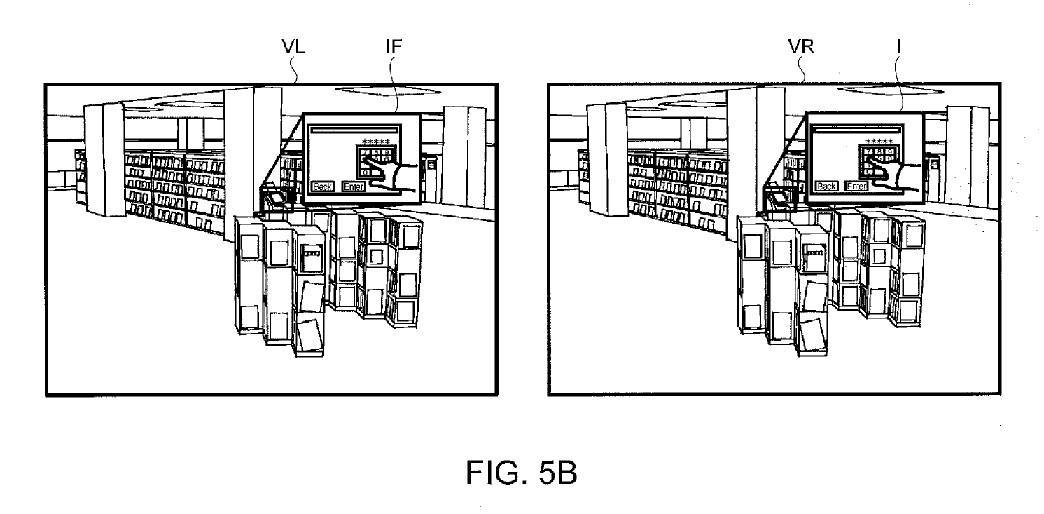

FIGS. 5A and 5B are explanatory diagrams each showing another display example of the head-mount type display device 100.

The display method selection section 185 selects the display method of the additional information in accordance with the importance of the additional information. The importance of the additional information is stored in the additional information database 121 with a string attached to each piece of the additional information. As shown in FIG. 5A, regarding the additional information high in importance, the display method selection section 185 selects the display method of performing display in an eye-friendly manner, or the display method of performing display with an emphasis in some way. The display method selection section 185 selects the display method of performing display with an emphasis in such a way as to decrease the transmittance of characters of the additional information high in importance, to use a bold face as the characters, or to use blink display for the characters. FIG. 5A shows the display image VL in the case in which a fire extinguisher or a sign showing the location of the fire extinguisher has been detected as the object. In the example shown in FIG. 5A, there is performed the blink display of the additional information IF showing the position of the fire extinguisher detected as the object.

In the case in which the additional information is the information difficult to visually recognize together with the external sight such as an image or a picture, the display method selection section 185 selects the display method for displaying the additional information in both of the right optical image display section 26 and the left optical image display section 28 as shown in FIG. 5B. As shown in FIG. 5B, the right display image VR is displayed on the right optical image display section 26, and the left display image VL is displayed on the left optical image display section 28. The right display image VR and the left display image VL shown in FIG. 5B each include the additional information IF in the case in which a book search system or a book lending system disposed in the library is detected as the object, and are the images for explaining the operation method of the system. As described above, in the case in which the additional information IF is represented by an image, a picture, or the like, the additional information IF is displayed on both of the right optical image display section 26 and the left optical image display section 28.

Further, although not shown in the drawings, it is possible for the display method selection section 185 to display the additional information in a way easier to understand in accordance with the type and the importance of the additional information. For example, it is also possible for the display method selection section 185 to display the information for emphasizing the additional information stored in advance in the additional information database 121 with a string attached to the additional information together with the additional information in accordance with the type and the importance of the additional information. The information for further emphasizing the additional information can also be an image or a moving image such as a character related to the additional information. Further, in the case in which the additional information is represented by characters, it is possible for the display method selection section 185 to perform display while arbitrarily changing the color, the size, the decoration or the design of the characters such as italic face, shaded font, or outline face of the characters for displaying the additional information. Further, it is also possible for the display method selection section 185 to perform display with the background color changed in order to display the additional information easier to understand.

Further, it is also possible for the display method selection section 185 to display the additional information as a 3D picture. The display method selection section 185 obtains the additional information as the 3D picture stored in advance in the additional information database 121. Then, the display method selection section 185 displays the additional information as the 3D picture on both of the right optical image display section 26 and the left optical image display section 28, and provides parallax to the display on the right optical image display section 26 and the left optical image display section 28 to thereby display the 3D picture.

It should be noted that the display method selection section 185 is realized as a function of the control section 140, and the action described above and performed by the display method selection section 185 can also be realized by another function of the control section 140. Further, is also possible to adopt a configuration in which the display method is selected using an operation of the user on the operation section 135, and the additional information can be displayed based on the display method thus selected.

The control section 140 displays (step S9) the additional information obtained by the additional information acquisition section 170 on the image display section 20 based on the pixel coordinate of the object detected by the object detection section 163 using the method selected by the display method selection section 185. The control section 140 displays the additional information related to the object so as to be superimposed on the object detected by the object detection section 163. Further, in the case in which either one of the right optical image display section 26 and the left optical image display section 28 is made to display the additional information, the control section 140 makes either one of the right optical image display section 26 and the left optical image display section 28 set in advance display the additional information. In the case of displaying the additional information on either one of the right optical display section 26 and the left optical image display section 28, it is also possible for the user to set which one of the right optical display section 26 and the left optical image display section 28 is made to display the additional information using the operation to the operation section 135.

Further, the head-mount type display device 100 can provide support for the user to find out the target book in the library. In the head-mount type display device 100, where the book, which the user has input via the operation section 135, is located can be displayed on the image display section 20. When the user input the book, which the user is looking for, via the operation section 135, the object detection section 163 obtains the recognition information of the book recorded in advance on the database. The object detection section 163 detects the recognition information matching the recognition information of the book in the taken image taken by the camera 61. The control section 140 displays the information representing the location of the book and the additional information on the image display section 20 so as to be superimposed on the recognition information detected by the object detection section 163.

Further, the head-mount type display device 100 can also be used as a system for providing the information for supporting work using the recognition information such as a marker in the case in which, for example, the user performs the work. In the system for providing information for the work support using the head-mount type display device 100, the recognition information such as a marker is attached to the work area such as a working desk or the vicinity thereof. The recognition information is imaged by the camera 61, and the object detection section 163 detects the recognition information from the taken image taken by the camera 61. The control section 140 displays the information for the work support, which is recorded in advance on the database with a string attached to the recognition information detected by the object detection section 163, on the image display section 20. On this occasion, the control section 140 selects the display method of the information for the work support based on the type of the information for the work support and the state of the external sight such as a work environment, and then displays the information on the image display section 20.

As explained hereinabove, the head-mount type display device 100 according to the embodiment on which the invention is applied is the transmissive display device for making the user visually recognize the image and at the same time transmitting the external sight, and is provided with the image display section 20 having the left optical image display section 28 for displaying the image corresponding to the left eye of the user and the right optical image display section 26 for displaying the image corresponding to the right eye of the user, the additional information acquisition section 170 for obtaining the additional information, and the control section 140 for making either one of the left optical image display section 28 and the right optical image display section 26 provided to the image display section 20 display the additional information obtained by the additional information acquisition section 170.

Therefore, since the additional information is displayed on either one of the left optical image display section 28 and the right optical image display section 26, the user can clearly view both of the additional information and the external sight. In other words, it is sufficient for the user to visually recognize the additional information which can be observed with one eye, and it is not required to combine the additional information which can be observed by the right eye and the additional information which can be observed by the left eye with each other to figure out as a single image. Therefore, when the user sees the additional information, the additional information can be observed together with the external sight without focusing on the additional information. By displaying the additional information to the one eye of the user in such a manner as described above, it is possible to achieve the visibility of both of the external sight and the additional information to thereby improve the convenience.

Further, in the head-mount type display device 100, there is provided the object detection section 163 for detecting the object, on which the additional information is superimposed, out of the external sight visually recognized through the image display section 20, and the control section 140 displays the additional information so as to be superimposed on the object having been detected by the object detection section 163. Therefore, since the additional information of the object thus detected is displayed so as to be superimposed on the object, the user can sensuously recognize the relationship between the additional information and the object. As described above, the visibility of both of the external sight and the additional information can be achieved, and the additional information can appropriately be displayed to thereby improve the convenience.

Further, in the head-mount type display device 100, there is provided the camera 61 for imaging the external sight, and the object detection section 163 detects the object, on which the additional information is superimposed, based on the taken image taken by the camera 61. Thus, since the object on which the additional information is superimposed is detected from the taken image, and then the additional information is displayed, it is possible to detect the object based on the condition of the recognition information stored in advance and so on. Thus, in the case in which the head-mount type display device 100 recognizes the recognition information from the taken image and then operates, an improvement in convenience can be achieved.

Further, in the head-mount type display device 100, there is provided the visual line detection section 161 for detecting the visual line direction of the user, and the control section 140 determines the display position at which the additional information is displayed based on the visual line direction detected by the visual line detection section 161. Thus, it is possible to display the additional information together with the external sight with respect to the object located in the visual line direction of the user. Therefore, even in the case in which a number of detection objects exist in the taken image taken by the camera 61, it is possible to identify the object located in the visual line direction of the user to display the additional information related to this object, and thus it is possible to improve the convenience in the case of detecting the object from the taken image to perform the operation.

Further, in the head-mount type display device 100, there is provided the display method selection section 185 for selecting the display method of the additional information, and the control section 140 displays the additional information based on the method selected by the display method selection section 185. Thus, the additional information can be displayed with the display method selected, and the additional information can appropriately be displayed together with the external sight to thereby improve the convenience.

Further, in the head-mount type display device 100, the display method selection section 185 changes the display method of the additional information in accordance with the environment of the external sight. Thus, it is possible to appropriately display the additional information together with the external sight to thereby improve the convenience.

Further, in the head-mount type display device 100, the display method selection section 185 selects the color of the additional information in accordance with the color of the external sight. Thus, it is possible to select the eye-friendly color with respect to the external sight such as the color rarely appearing in the external sight, and thus, it is possible to appropriately display the additional information together with the external sight to thereby improve the convenience.

Further, in the head-mount type display device 100, the display method selection section 185 changes the transmittance of the additional information in accordance with the brightness of the external sight. Thus, by decreasing the transmittance of the additional information in the case in which the external sight is bright, and increasing the transmittance of the additional information in the case in which the external sight is dark, the additional information can be displayed so as to be eye-friendly with respect to the external sight. Therefore, it is possible to appropriately display the additional information together with the external sight to thereby improve the convenience.

Further, in the head-mount type display device 100, the display method selection section 185 changes the display method of the additional information in accordance with the importance of the additional information. Thus, regarding the important additional information, for example, the additional information can be displayed with an emphasis, and the additional information can appropriately be displayed together with the external sight to thereby improve the convenience.

Further, in the head-mount type display device 100, the display method selection section 185 switches whether either one of the left optical image display section 28 and the right optical image display section 26 is made to display the additional information, or both of the left optical image display section 28 and the right optical image display section 26 are made to display the additional information in accordance with the type of the additional information. Thus, the display method selection section 185 makes either one of the left optical image display section 28 and the right optical image display section 26 display the additional information in the case in which the additional information is represented by characters, or makes both of the left optical image display section 28 and the right optical image display section 26 display the additional information in the case in which the additional information is represented by an image or a picture. Therefore, it is possible to appropriately display the additional information together with the external sight to thereby improve the convenience.

Further, the invention is not limited to the configuration of the embodiment described above, but can be implemented in various forms within the scope or the spirit of the invention. For example, it is also possible to eliminate one of the direction keys 16 and the track pad 14 provided to the control device 10, or to provide another operating interface such as an operating stick in addition to or instead of the direction keys 16 and the track pad 14. Further, it is also possible to assume that the control device 10 has a configuration in which an input device such as a keyboard or a mouse is connected to the control section 10, and receives an input from the keyboard or the mouse.

Further, it is also possible to adopt an image display section of another system such as an image display section to be worn like a hat as the image display section instead of the image display section 20 to be worn like a pair of glasses. Further, although in the embodiment described above, it is assumed that the head-mount type display device 100 is of the binocular transmissive type, the invention can also be similarly applied to other types of head-mount type display devices such as a video transmissive type or a monocular type. Further, it is also possible to adopt a configuration as the head-mounted display installed in a mobile object such as a vehicle or a plane. Further, for example, the invention can also be implemented as a head-mounted display incorporated in a physical security device such as a helmet, or a head-up display (HUD) used in a front glass of a vehicle.

Further, although in the embodiment described above, the explanation is presented citing the configuration in which the image display section 20 and the control device 10 are separated from each other, and are connected to each other via the connection section 40 as an example, it is also possible to adopt a configuration in which the control device 10 and the image display section 20 are configured integrally to be mounted on the head of the user.

Further, the control device 10 and the image display section 20 are connected to each other with a longer cable or a wireless communication line, and as the control device 10, there can also be used a laptop computer, a tablet computer, a desktop computer, a portable electronic device including a game machine, a portable phone, a smartphone, and a portable media player, or other dedicated devices.

Further, although in the embodiment described above, the control device 10 has the configuration of obtaining the present position based on the GPS signal using the GPS 115, the invention is not limited to this configuration. The control device 10 can also measure the present position based on the radio waves from WiFi access points received by the communication section 117.

Further, for example, it is also possible to adopt a configuration provided with an organic EL (organic electro-luminescence) display and an organic EL control section, or to use LCOS (liquid crystal on silicon; LCoS is a registered trademark), a digital micromirror device, or the like as the configuration of generating the image light in the image display section 20. Further, for example, it is also possible to apply the invention to a laser retinal projection head-mounted display. Specifically, it is also possible to adopt a configuration in which the image generation section is provided with a laser source and an optical system for guiding the laser beam to the eyes of the user, makes the laser beam enter the eyes of the user, and then scans the surface of the retina with the laser beam to provide an image on the retina to thereby make the user visually recognize the image. In the case of adopting the laser retinal projection head-mounted display, an “area to which the image light can be emitted in the image light generation section” can be defined as an image area recognized by the eyes of the user.

As the optical system for guiding the image light to the eyes of the user, there can be adopted a configuration in which an optical member for transmitting the outside light entering from the outside toward the device, and the outside light is made to enter the eyes of the user together with the image light. Further, it is also possible to use an optical member located in front of the eyes of the user to overlap a part or the whole of the field of view of the user. Further, it is also possible to adopt a scanning type optical system for causing a scanning movement of the laser beam or the like to form the image light. Further, the invention is not limited to those guiding the image light inside the optical member, but those only provided with a function of guiding the image light by refracting and/or reflecting the image light toward the eyes of the user can also be adopted.

Further, it is also possible to apply the invention to a display device adopting the scanning optical system using an MEMS mirror, and using the MEMS display technology. In other words, as the image display element, it is also possible to provide a signal light forming section, a scanning optical system having the MEMS mirror for causing the scanning movement of the light emitted by the signal light forming section, and an optical member on which a virtual image is formed by the light the scanning movement of which is caused by the scanning optical system. In this configuration, the light emitted by the signal light forming section is reflected by the MEMS mirror, enters the optical member, and is guided through the optical member, and then reaches a virtual image forming surface. By the MEMS mirror causing the scanning movement of the light, the virtual image is formed on the virtual image forming surface, and by the user figuring out the virtual image with the eyes, the image is recognized. An optical component used in this case can be a component for guiding the light through a plurality of times of reflection similarly to, for example, the right light guide plate 261 and the left light guide plate 262 in the embodiment described above, or can be realized using a half-mirror surface.

Further, the display device according to the invention is not limited to the head-mount type display device, but can be applied to a variety of types of display device such as a flat-panel display or a projector. The display device according to the invention is only required to make the user visually recognize an image using the image light together with the outside light, and there can be cited, for example, a configuration of making the user visually recognize the image by the image light using the optical member transmitting the outside light. Specifically, besides the configuration of providing the optical member for transmitting the outside light in the head-mounted display described above, the display device according to the invention can also be applied to a display device for projecting the image light on a plane of a curved surface (glass or transparent resin) having a light transmissive property fixedly or movably disposed at a position distant from the user. As an example, there can be cited a configuration of a display device for projecting the image light on a window glass of a vehicle to make the user in the vehicle or the user outside the vehicle visually recognize the scenery inside and outside the vehicle together with the image by the image light. Further, there can also be cited a configuration of a display device for projecting the image light on a transparent, semi-transparent, or colored transparent display surface fixedly installed such as a window glass of a building to make the user located around the display surface visually recognize the scenery through the display surface together with the image by the image light.

Further, at least a part of each of the functional blocks shown in FIG. 2 can be realized with hardware, or can be provided with a configuration realized by cooperation between hardware and software, and the invention is not limited to the configuration of arranging the independent hardware resources in the same manner as shown in FIG. 2. Further, a program executed by the control section 140 can be stored in the storage section 120 or a storage device inside the control device 10, or it is also possible to adopt a configuration of obtaining the program stored in an external device via the communication section 117 or the interface 180 to execute the program. Further, among the constituents formed in the control device 10, only the operation section 135 is formed as a user interface (UI), or the power supply 130 in the embodiment described above is formed alone as a replaceable constituent. Further, the constituents formed in the control device 10 can also be formed in the image display section 20 in an overlapping manner. For example, the control section 140 shown in FIG. 2 can also be provided to both of the control device 10 and the image display section 20, and it is also possible to adopt a configuration in which the functions respectively performed by the control section 140 provided to the control device 10 and the CPU provided to the image display section 20 are separated from each other.

The entire disclosure of Japanese Patent Application No.2014-145670, filed Jul. 16, 2014 is expressly incorporated by reference herein.

What is claimed is:

1. A transmissive display device adapted to make a user visually recognize an image and transmit an external sight, comprising:
an image display section having a first display section adapted to display an image corresponding to a left eye of the user, and a second display section adapted to display an image corresponding to a right eye of the user;
an additional information acquisition section adapted to obtain additional information; and
a control section adapted to make either one of the first display section and the second display section included in the image display section, display the additional information obtained by the additional information acquisition section.

2. The display device according to claim 1, further comprising:
an object detection section adapted to detect an object on which the additional information is superimposed out of the external sight visually recognized through the display section,
wherein the control section makes the additional information be displayed so as to be superimposed on the object detected by the object detection section.

3. The display device according to claim 2, further comprising:
an imaging section adapted to take an image of the external sight,
wherein the object detection section detects the object, on which the additional information is superimposed, based on the image taken by the imaging section.

4. The display device according to claim 1, further comprising:
a visual line direction detection section adapted to detect a visual line direction of the user,
wherein the control section determines a display position, at which the additional information is to be displayed, based on the visual line direction detected by the visual line detection section.

5. The display device according to claim 1, further comprising:
a display method selection section adapted to select a display method of the additional information,
wherein the control section makes the additional information be displayed based on the display method selected by the display method selection section.

6. The display device according to claim 5, wherein
the display method selection section changes the display method of the additional information in accordance with an environment of the external sight.

7. The display device according to claim 5, wherein
the display method selection section selects a color of the additional information in accordance with a color of the external sight.

8. The display device according to claim 5, wherein
the display method selection section changes a transmittance of the additional information in accordance with a brightness of the external sight.

9. The display device according to claim 5, wherein
the display method selection section changes the display method of the additional information in accordance with importance of the additional information.

10. The display device according to claim 5, wherein
the display method selection section switches whether either one of the first display section and the second display section is made to display the additional information or both of the first display section and the second display section are made to display the additional information in accordance with a type of the additional information.

11. A method of controlling a transmissive display device adapted to make a user visually recognize an image and transmit an external sight, the method comprising:
providing an image display section having a first display section adapted to display an image corresponding to a left eye of the user, and a second display section adapted to display an image corresponding to a right eye of the user;
obtaining additional information; and
making either one of the first display section and the second display section display the additional information.

12. A computer executable program adapted to control a transmissive display device adapted to make a user visually recognize an image and transmit an external sight, including an image display section having a first display section adapted to display an image corresponding to a left eye of the user, and a second display section adapted to display an image corresponding to a right eye of the user, the program making a computer function as a device comprising:
an additional information acquisition section adapted to obtain additional information; and
a control section adapted to make either one of the first display section and the second display section display the additional information obtained by the additional information acquisition section.
